(19) United States
(12) Patent Application Publication
(10) Pub. No.: US 2026/0253016 A1
(43) Pub. Date: Aug. 27, 2026

(54) SYSTEM AND A METHOD FOR WORKPLACE MONITORING AND SECURE ACCESS CONTROL

(71) Applicant: Kingfisher Innovations, Inc., Houston, TX (US)

(72) Inventors: Andrew Brett Gilmer, Parkland, FL (US); Mitchell Gilmer, Wauwatosa, WI (US); Steve Gotberg, Corpus Christi, TX (US); Theresa Ruiz, Little Elm, TX (US); RhaeAnn C. Stark, Corpus Christi, TX (US); Mitchell Kalogridis, Houston, TX (US)

(73) Assignee: Kingfisher Innovations, Inc., Houston, TX (US)

(21) Appl. No.: 19/206,469

(22) Filed: May 13, 2025

Related U.S. Application Data
(63) Continuation-in-part of application No. 19/063,690, filed on Feb. 26, 2025.

(51) Int. Cl. G06Q 10/0639; G06F 21/44; G07C 9/00

(52) U.S. Cl. CPC G06Q 10/06393; G06F 21/44; G07C 9/00182; G07C 9/00896; G07C 2009/00261

(57) ABSTRACT

Embodiments of the present invention provide a system and method for workplace monitoring and access control, integrating user authentication, task verification, and security enforcement. The system comprises an identification device associated with a user, a task verification system, and an door access management module. The task verification system detects user presence, logs task-related events, verifies task completion, and generates alerts for non-compliance. The door access management module authenticates users, regulates entry into secured areas, and triggers security alerts for unauthorized access attempts. The system dynamically adjusts access permissions and task validation based on predefined conditions, user roles, and historical compliance data. Notifications and reports are generated via a centralized interface, providing real-time updates, key performance indicators, and compliance tracking.

### TECHNICAL FIELD

The present invention generally relates to a monitoring and access control system. More specifically, relates to an Intelligent System for Workforce Compliance, Task Tracking, and Access Management. The system is designed to manage task completion, monitor personnel presence in designated work areas, and regulate access to restricted zones using an innovative Internet-of-Things (IoT) framework.

### BACKGROUND

In many workplaces, such as convenience stores, restaurants, and other fast-paced environments, it is essential to ensure that employees complete their assigned tasks efficiently and consistently. Managers must balance the need for oversight with the desire to minimize direct supervision, allowing employees to perform their duties without constant reminders. However, without an effective system in place, there is a risk of tasks being overlooked or completed improperly, which can impact overall operational efficiency and customer satisfaction.

In addition to task management, such workplaces often contain restricted areas, including stockrooms, lockers, and refrigeration units, that require controlled access. It is critical to track and log access to these areas, ensuring that only authorized personnel can enter based on their assigned roles. Unauthorized access can lead to security risks, inventory discrepancies, or non-compliance with safety regulations.

Traditional methods, including manual checklists, logbooks, mechanical locks, and standalone keycard systems, often lack real-time monitoring, are prone to human error, and require active oversight. These approaches can result in incomplete tasks, unauthorized access, security breaches, and non-compliance with safety regulations. While some digital solutions, such as electronic logging and access control systems, exist, they frequently operate in isolation, failing to integrate task completion tracking with access management.

There is a need for an automated, scalable, and integrated system that seamlessly monitors employee task adherence, verifies presence, and controls access in real time. Such a system should enhance accountability, minimize inefficiencies, and provide actionable insights through data-driven analytics. The present invention addresses these challenges by introducing an intelligent, wireless-enabled ecosystem that links task verification with secure access control, ensuring both compliance and operational effectiveness.

### OBJECTIVES OF THE INVENTION

Some of the objects of the invention are as follows:

An object of the present invention is to provide a workplace monitoring and access control system that ensures secure, efficient, and automated tracking of user activities, task adherence, and access authorization.

Another object of the present invention is to enhance workplace security and productivity by integrating user authentication, task monitoring, and access control into a unified system.

Another object of the present invention is to provide a system that provides automated user authentication.

Another object of the present invention is to provide a system that tracks task-related activities, logs task completion, and triggers alerts for missed or incomplete tasks based on predefined schedules and conditions.

Another object of the present invention is to system that provides dynamic access control by regulating user entry to secured areas based on authentication credentials and predefined access rules, ensuring only authorized personnel gain access.

Another object of the present invention is to provide a system that generates real-time alerts for unauthorized access attempts, missed tasks, or security breaches, with notifications delivered via push notifications, SMS, or email.

Another object of the present invention is to provide a system that provides insights into workforce compliance, security incidents, and operational efficiency through real-time dashboards, historical reports, and key performance indicators (KPIs).

Another object of the present invention is to provide a system that ensures secure storage and transmission of access logs, task completion data, and authentication details through encryption and multi-factor authentication.

### SUMMARY OF THE INVENTION

The present invention provides a workplace monitoring and access control system designed to enhance security, efficiency, and compliance in controlled environments. The system integrates user authentication, task monitoring, and access regulation to ensure that personnel adhere to assigned tasks while maintaining secure access to restricted areas.

According to a first aspect of the invention, a system for workplace monitoring and access control is provided. The system comprising: an identification device, associated with a user, configured to enable authentication and communication with the system; a task verification system, configured to: detect the presence of the identification device within a designated area, log task-related events, verify task completion based on predefined conditions; an door access management module, configured to: authenticate the identification device for access authorization, regulate entry to a secured area via an access control mechanism, generate alerts in response to unauthorized access attempts.

In one embodiment of the invention, the system further comprising an interface configured to display status updates regarding task completion and access control and generate reports related to user activity and compliance.

In one embodiment of the invention, the system dynamically adjusts monitoring and access control based on user status and predefined operational criteria.

In one embodiment of the invention, the task verification system comprises: a countdown time requiring periodic resets to confirm task completion; a reader to detect an unauthorized identification device; and a proximity detection system to verify a user's presence within a specified range.

In one embodiment of the invention, the door access management module comprises: a door access control mechanism integrated with third-party electronic locks; and an alert system for unauthorized access attempts.

In one embodiment of the invention, the task verification system operates in a contact mode, requiring physical interaction with the identification device for validation.

In one embodiment of the invention, the task verification system operates in a proximity mode, detecting the identification device within a defined range.

In one embodiment of the invention, the door access management module provides a time-limited access window upon successful authentication.

In one embodiment of the invention, alerts from the task verification system and door access management module are escalated via push notifications, SMS, or email based on severity levels.

In one embodiment of the invention, the interface generates key performance indicators (KPIs) and historical analytics for user task adherence and access behavior.

According to a second aspect of the invention, a method for workplace monitoring and access control is provided. The method comprising: assigning a user an identification device uniquely associated with the user's identity; deploying a task verification system at task locations to: detect the identification device using wireless communication log task completion events and timestamps, triggering alerts for missed tasks based on a predefined schedule; utilizing an door access management module to: verify identification device credentials before granting access, log authorized and unauthorized access attempts trigger security alerts upon detecting unauthorized entry attempts.

In one embodiment of the invention, the method further comprising: providing an interface to: display task adherence and access control status in real-time, and generate reports on user compliance and security events.

In one embodiment of the invention, the identification device comprises a wireless communication module configured to facilitate authentication via at least one near-field communication (NFC), ultra-wideband (UWB), Bluetooth, or RFID.

In one embodiment of the invention, the task verification system dynamically adjusts task validation intervals based on user role, location, or historical compliance data.

In one embodiment of the invention, the door access management module temporarily overrides access restrictions in response to emergency conditions or supervisor authorization.

In one embodiment of the invention, task completion and access control data are secured using encryption and multi-factor authentication to ensure data integrity and prevent unauthorized modifications.

In one embodiment of the invention, the system interface integrates with third-party workforce management software to synchronize work schedules, task assignments, and user access permissions.

In one embodiment of the invention, alerts generated by the task verification system and door access management module are categorized by severity and delivered via multiple communication channels, including push notifications, SMS, email, or automated voice messages.

In one embodiment of the invention, the system interface provides predictive analytics to identify patterns in task adherence and access behavior, enabling proactive workforce optimization.

In one embodiment of the invention, access attempts and task completion events are logged with geolocation metadata for enhanced auditability and compliance tracking.

In the context of the specification, the term ‘identification device’ includes, but is not limited to, any electronic, optical, biometric, or wireless communication device capable of storing or transmitting authentication credentials. Examples include RFID tags, NFC-enabled cards, Bluetooth beacons, UWB devices, biometric tokens, and smart cards.

In the context of the specification, the phrase ‘task monitoring’ as used herein refers to the process of tracking user presence, activity, or task completion through automated detection mechanisms. This may include detecting user proximity, requiring active confirmation of task execution, logging timestamps, or verifying adherence to predefined operational criteria.

In the context of this specification, the term ‘access control’ encompasses any mechanism used to regulate entry into restricted areas based on authentication credentials. Such mechanisms may include electronic locks, biometric scanners, PIN-based entry systems, and software-based access authorization protocols.

In the context of this specification, the term ‘alert’ or ‘notification’ as used herein refers to any automated system-generated message intended to inform an administrator or user of a security event, task non-compliance, or unauthorized access attempt. Alerts may be delivered via push notifications, SMS, email, audible alarms, or visual indicators.

In the context of the specification, the phrase ‘proximity detection’ refers to the ability of the system to determine the presence of an identification device within a predefined range. This may be achieved through radio frequency signals, infrared sensors, motion detectors, or other suitable technologies.

In the context of the specification, the term ‘authentication’ refers to the process of verifying a user's identity before granting access or validating task completion. Authentication methods may include but are not limited to, biometric verification (fingerprint, facial recognition, retina scan), token-based authentication (RFID, NFC, UWB, Bluetooth devices), password/PIN-based authentication, or multi-factor authentication (MFA).

In the context of the specification, the term ‘task completion verification’ as used herein refers to the process of ensuring that a designated task has been properly executed by an authorized user. Such verification may include scanning an identification device, recording a user's presence for a predefined duration, receiving manual input confirmation, or automatically logging task completion based on sensor data.

In the context of the specification, the term ‘secure area’ refers to any designated physical or digital space that requires authorization for entry. A secure area may include restricted office zones, data centers, manufacturing zones, healthcare facilities, high-security labs, or digital environments requiring credential-based access.

In the context of the specification, the term ‘unauthorized access’ as used herein refers to any attempt to enter a secure area or perform a restricted task without proper authentication. Unauthorized access may include failed authentication attempts, the use of invalid credentials, tailgating (following an authorized user without verification), or forced entry attempts.

In the context of the specification, the term ‘dynamic access control’ refers to an adaptive security mechanism that adjusts access permissions based on real-time conditions such as user status, location, security level, or historical behavior. Dynamic access control may involve temporary access grants, role-based permissions, or emergency overrides.

In the context of the specification, the term ‘compliance tracking’ refers to the process of monitoring and ensuring that users adhere to workplace policies, task schedules, and security protocols. Compliance tracking may involve logging user activities, generating audit trails, and issuing reports for regulatory or operational review.

In the context of the specification, the term ‘multi-channel alerts’ as used herein refers to notifications or warnings delivered via multiple communication methods, including but not limited to push notifications, SMS, email, automated voice calls, or on-screen system alerts. These alerts may be triggered by security breaches, missed tasks, or policy violations.

In the context of the specification, the term ‘predictive analytics’ refers to the use of historical workforce data and machine learning algorithms to identify patterns in task adherence, security incidents, and user behavior. Predictive analytics may be used to forecast potential security threats, optimize workforce scheduling, and enhance compliance strategies.

In the context of the specification, the term ‘proximity-based authentication’ as used herein refers to an authentication method where a user's identification device is detected within a predefined range to grant access or verify task completion. This may include short-range wireless communication technologies such as Bluetooth, NFC, RFID, or Ultra-Wideband (UWB).

In the context of the specification, the term ‘centralized user interface’ refers to a software dashboard or control panel that provides administrators with real-time status updates, access logs, task compliance reports, security alerts, and system configuration settings. The interface may be accessible via web applications, mobile devices, or integrated enterprise management platforms.

In the context of the specification, the term ‘geo-tagging’ or ‘location tracking’ as used herein refers to the process of associating user activities, access events, or task completion logs with geolocation metadata. Location tracking may be implemented using GPS, RFID-based zone mapping, Wi-Fi triangulation, or other positioning technologies to enhance security and auditability.

In the context of the specification, the term ‘emergency override mechanism’ refers to a security feature that allows temporary bypassing of access restrictions in response to predefined emergency conditions. Such conditions may include fire alarms, medical emergencies, or supervisor-approved overrides. The system may grant temporary access based on predefined rules, biometric verification, or remote authorization.

### BRIEF DESCRIPTION OF THE ACCOMPANYING DRAWINGS

The accompanying drawings illustrate the best mode for carrying out the invention as presently contemplated and set forth hereinafter. The present invention may be more clearly understood from a consideration of the following detailed description of the preferred embodiments taken in conjunction with the accompanying drawings wherein like reference letters and numerals indicate the corresponding parts in various figures in the accompanying drawings, and in which:

FIG. 1 is a block diagram showing various components of a system for workplace monitoring and access control, in accordance with an embodiment of the present invention.

FIG. 2 is a block diagram illustrating communication architecture of the system, showing the interaction between different components of the system, in accordance with an embodiment of the present invention.

FIG. 3 illustrates the internal architecture and component layout of the Gateway, which serves as the central field-level communication hub between the door access management module, the task verification system, the proximity detection device, and the Server, in accordance with an embodiment of the present invention.

FIG. 4 illustrates the logical flow of operations performed within the Gateway module when interacting with an identification device during a scan event, in accordance with an embodiment of the present invention.

FIG. 5 illustrates an information flow diagram of a Door Access, Task Monitoring, and Control System, in accordance with an embodiment of the present invention.

FIG. 6 illustrates the internal architecture of an identification device worn by personnel and is designed to interface seamlessly with the door access management module and the task verification system, in accordance with an embodiment of the present invention.

FIG. 7 illustrates the operational process flow within the identification device Reader, which is embedded in the door access management module or the task verification system, in accordance with an embodiment of the present invention.

FIG. 8A illustrates a task verification system, in accordance with an embodiment of the present invention.

FIG. 8B illustrates an internal architecture of the task verification system, in accordance with an embodiment of the present invention.

FIG. 9 illustrates an NFC-triggered task verification system for task monitoring and compliance tracking, in accordance with an embodiment of the present invention.

FIG. 10 illustrates an exemplary process for configuring the task verification system, in accordance with an embodiment of the present invention.

FIG. 11 is a flow diagram representing an exemplary method of operation for a task verification system, in accordance with an embodiment of the present invention.

FIG. 12A illustrates a proximity detection device, in accordance with an embodiment of the present invention.

FIG. 12B illustrates an internal architecture of the proximity detection device, in accordance with an embodiment of the present invention.

FIG. 13 illustrates a system for monitoring staff presence at designated locations using a task verification system, in accordance with an embodiment of the present invention.

FIG. 14 illustrates an operational flow for the proximity detection device, detailing the detection, authorization, caching, and timer-reset logic as performed by the proximity detection device during regular operation, in accordance with an embodiment of the present invention.

FIG. 15 illustrates a hardware implementation of the door access management module responsible for personnel tracking and access management, in accordance with an embodiment of the present invention.

FIG. 16 illustrates a system for monitoring doorway access and unauthorized entry using NFC-enabled checkpoints, surveillance cameras, and automated alerts, in accordance with an embodiment of the present invention.

FIG. 17 is a functional flow diagram of the door access management module, illustrating the process flow from identification device detection to door access management and door state monitoring, in accordance with an embodiment of the present invention.

FIG. 18 illustrates the architecture of the Dashboard, which serves as a supervisory control and visualization interface, in accordance with an embodiment of the present invention.

FIG. 19 illustrates a system interface for generating and managing security alerts related to an intrusion event in a monitored area, in accordance with an embodiment of the present invention.

FIG. 20 illustrates a system-level architecture for real-time personnel performance monitoring and key performance indicator (KPI) tracking, in accordance with an embodiment of the present invention

### DETAILED DESCRIPTION

Embodiments of the present invention disclosure will be described more fully hereinafter with reference to the accompanying drawings in which like numerals represent like elements throughout the figures, and in which example embodiments are shown.

The detailed description and the accompanying drawings illustrate the specific exemplary embodiments by which the disclosure may be practiced. These embodiments are described in detail to enable those skilled in the art to practice the invention illustrated in the disclosure. It is to be understood that other embodiments may be utilized, and other changes may be made, without departing from the spirit or scope of the present disclosure. The following detailed description is therefore not to be taken in a limiting sense, and the scope of the present invention disclosure is defined by the appended claims. Embodiments of the claims may, however, be embodied in many different forms and should not be construed as limited to the embodiments set forth herein.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited only to those elements but may include other elements not expressly listed or inherent to such a process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such non-limiting examples and illustrations includes, but is not limited to: “for example,” “for instance,” “e.g.,” “in one embodiment”.

The present invention relates to an integrated workplace monitoring and access control system that enhances operational efficiency, task compliance, and security enforcement through a multi-device architecture. The system ensures that employees or authorized personnel comply with predefined workplace procedures while preventing unauthorized access to restricted areas. The invention can be implemented in various industries, including corporate environments, manufacturing, healthcare, and security-sensitive facilities.

The system comprises a proximity detection device, a task verification system, and a door access management module. The proximity detection device is configured to detect and log the presence of employees, either individually or by role group, within a programmable range. The proximity detection device ensures that critical service areas, such as a reception desk or inspection zone, remain appropriately staffed during operational hours. The presence of a user may be verified through wireless telemetry, check-in scans, or passive detection based on proximity sensors.

The proximity detection device senses an identification device, which is a portable authentication unit assigned to each user, facilitating communication with the system. This device can be an RFID tag, NFC-enabled card, Bluetooth beacon, ultra-wideband (UWB) device, biometric token, or smart card. The identification device functions as both an access credential and a task verification tool.

The task verification system is responsible for monitoring task adherence and verifying task completion based on predefined conditions. The task verification system enforces compliance with periodic activities through the use of countdown timers. The task verification system logs task-related events, timestamps, and user interactions. A countdown timer requires periodic user interaction or presence validation to confirm task execution. The timers are associated with tasks or presence requirements that must be completed within designated intervals by employees who are specifically trained or authorized. The task verification system may be tied to a physical location (such as a restroom or inspection point) or to mobile tasks that require scanning or presence confirmation through Near-Field Communication (NFC) or equivalent technologies. The module also includes an unauthorized device detection system to identify attempts to bypass the system using unauthorized devices.

The task verification system operates in two modes: contact mode and proximity mode. In contact mode, users must physically interact with the module using their identification device to reset the countdown timer. This mode is particularly useful for scheduled inspections or security rounds. In proximity mode, the task verification system detects the identification device within a defined radius, ensuring personnel are present in required locations such as a front desk, security station, or hostess stand. If a user fails to complete the required interaction within the predefined timeframe, an alert is generated and escalated based on severity.

The door access management module ensures secure entry into restricted areas and logs all access attempts. The door access management module operates using a multi-tiered authentication protocol based on the employees'real-time status in the organization's time clock system. The authentication system verifies credentials before granting access. The door access management module integrates with third-party electronic locks to regulate entry. Access rights are dynamically evaluated based on whether the employee is clocked in and whether their assigned role permits entry into specific secure areas, thus preventing unauthorized or unintended access attempts. Additionally, it includes an alert system that generates notifications for unauthorized access attempts. The module also incorporates a time-limited access feature, granting temporary access based on predefined authorization conditions. Employees must scan their identification devices before accessing monitored areas, and unauthorized attempts are logged and reported.

The proximity detection device, the task verification system, and the door access management module are interconnected and managed through the system, which collects real-time data across all employee interactions, including task completion, access event, and location compliance. The system organizes the data at multiple operation levels, such as individual employees, role-based teams, work shifts, and management hierarchies.

The collected data is processed and analyzed through an Insight Analytics platform, which generates Key Performance Indicators (KPIs), compliance reports, and workforce productivity metrics. The Insight Analytics platform generates reports related to user activity, security incidents, and compliance. This data serves as a foundation for performance evaluations, managerial oversight, and organizational auditing. Additionally, the raw metrics can be exported in standardized datasets for long-term archival, third-party system integration, or business intelligence applications. The stored data is accessible through centralized tablets, employee break rooms, manager offices, or as a mobile application for remote monitoring.

In the task monitoring workflow, when a user enters a designated task area carrying their identification device, the task verification system detects its presence and logs the event. If a task requires periodic validation, the system prompts the user to confirm execution by interacting with the identification device or remaining within the defined range. If the user fails to complete the task within the designated timeframe, an alert is generated. The system updates the user's compliance status in the user interface for managerial review.

In the access control workflow, the user presents their identification device to an access control terminal. The module verifies credentials against stored authentication data. If authentication is successful, the door access mechanism is triggered, allowing entry. If authentication fails, an alert is generated, notifying administrators via SMS, email, or push notification. The system logs all access attempts, including timestamps and geolocation metadata for audit purposes.

The system dynamically adjusts its operation based on various factors, including user role-based access, historical compliance data, emergency override mechanisms, and integration with workforce management software. Role-based access ensures different clearance levels and task validation criteria based on job role. Historical compliance data adjusts task verification intervals based on previous adherence patterns. The emergency override mechanism temporarily bypasses access restrictions in response to emergencies or supervisor approval. Integration with workforce management software synchronizes schedules, assignments, and access permissions.

To ensure security and data integrity, encryption is implemented for authentication and task-related data. Multi-factor authentication (MFA) enhances security through additional verification methods such as biometric scanning or PIN entry. Geo-tagging logs access and task completion events with location metadata for enhanced auditability. A multi-channel alerting system categorizes alerts based on severity and delivers notifications through multiple communication channels.

The system enables seamless communication between all components, including the task verification system, door access management module, identification devices, and Insight Analytics platform, using secure wireless protocols such as LoRaWAN, UWB, NFC, and BLE. Each device is registered within the network to ensure secure interoperability. The user interface serves as a centralized monitoring and management tool, providing real-time visibility into task adherence, access control events, and security alerts.

In an embodiment of the present invention, the system for workplace monitoring and access control comprises an identification device, a task verification system, a door access management module, and a centralized monitoring interface.

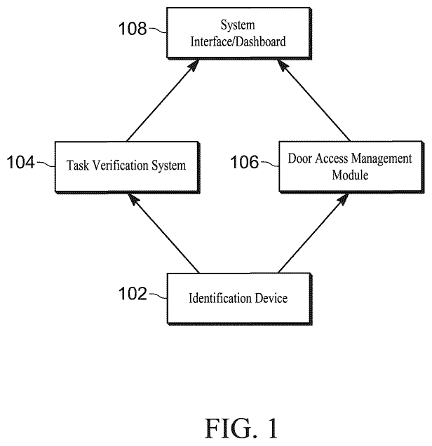

FIG. 1 is a block diagram showing various components of a system for workplace monitoring and access control. The system comprises an identification device 102, a task verification system 104, a door access management module 106, and a system interface (dashboard) 108.

The Identification Device 102 is a hardware component integrated with an embedded software system, a real-time clock (RTC), and wireless communication capabilities. Designed to resemble a standard employee ID worn on a lanyard, the Identification Device 102 facilitates secure authentication, task monitoring, and access control within the system. The Identification Device 102 supports multiple wireless communication protocols, including Near Field Communication (NFC) for short-range authentication and Ultra-Wideband (UWB) for precise proximity-based tracking. Each Identification Device 102 is uniquely assigned to an employee through the Dashboard or the system interface 108, ensuring that all interactions, such as task verification and access attempts, are accurately logged and attributed to the correct individual.

The Identification Device 102 interacts with both the Task verification system 104 and the Door access management module 106. The system verifies employee presence at designated locations, ensuring adherence to scheduled tasks. Employees may need to tap the Identification Device 102 against a terminal or remain within a defined range for verification, and failure to comply within the required timeframe triggers alerts. In access control, employees present their Identification Device 102 at a reader to authenticate entry into restricted areas, with permissions validated against stored credentials. Unauthorized attempts are logged and reported to administrators.

To enhance security, the Identification Device 102 employs encrypted communication to prevent data interception or spoofing. It can also support multi-factor authentication (MFA) by integrating biometric verification, such as fingerprint scanning, for additional security. Some models may include tamper detection features to identify unauthorized modifications. Given its continuous use throughout an employee's shift, the Identification Device 102 is designed for power efficiency, utilizing passive NFC, low-energy UWB, and Bluetooth Low Energy (BLE) to minimize battery drain. It may be powered by a rechargeable or replaceable battery, ensuring long-term usability.

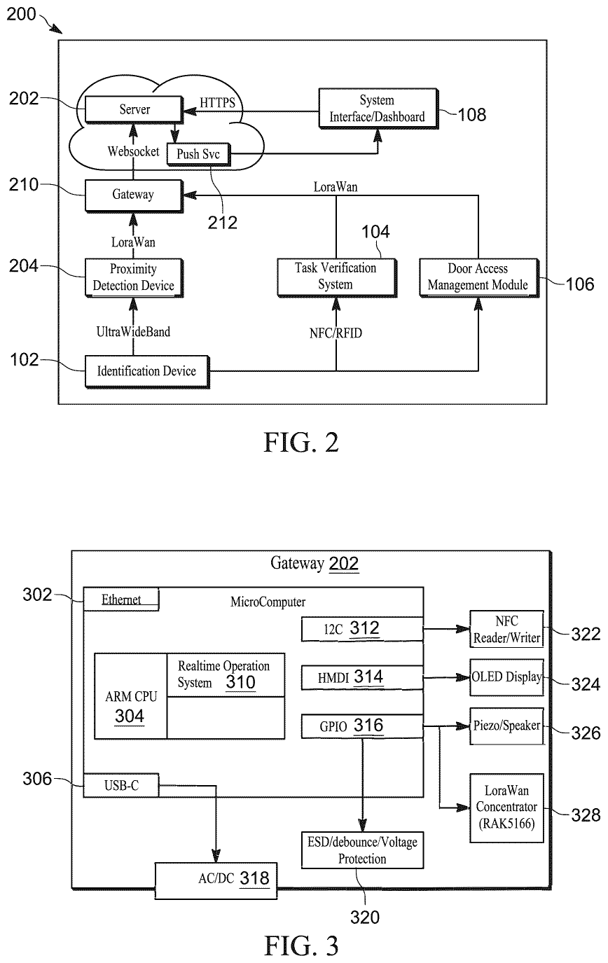

FIG. 2 is a block diagram illustrating the communication architecture of the system, showing the interaction between different components of the system. The system 200 is centered around a cloud-based Server 202, which serves as the central processing unit for all data received from the field modules. The Server communicates with the system interface/Dashboard 108 via secure HTTPS protocols to provide real-time dashboards, alerts, and performance analytics to end-users such as administrators or supervisors.

The field-level communication is mediated through a Gateway 210, which connects to the Server 202 using a persistent WebSocket connection to enable low-latency, bidirectional data transmission. The Gateway 210 is configured to receive data from multiple endpoint devices over a LoRaWAN (Long Range Wide Area Network) protocol, ensuring low power consumption and extended communication range.

The door access management module 106 and the task verification system 104 are each equipped to communicate with the Gateway 210 over LoRaWAN. Both modules receive identification input from the identification device 102, which may use NFC or RFID technologies for short-range wireless communication. The door access management module 106 verifies access credentials and manages physical entry points based on access permissions tied to employee roles and schedules. The task verification system 104 monitors task-specific interactions such as timed verifications or checkpoints, ensuring periodic duties are performed by authorized individuals.

In parallel, the proximity detection device 204 also communicates with the Gateway 210 using LoRaWAN and is designed to detect the presence of an identification device 102 within a defined physical radius using Ultra-Wideband (UWB) technology. This allows for continuous presence tracking of employees in key operational zones without requiring manual check-ins.

The identification device 102, which is worn or carried by personnel, acts as a passive identifier and interacts with the door access management module 106, the task verification system 104, and the proximity detection device 204 through appropriate protocols (NFC/RFID for direct interaction and UWB for proximity detection). Data from all these modules—access logs, task completions, and proximity events—are aggregated at the Gateway 210 and transmitted to the Server 202. From there, the data is processed, stored, and visualized through the system interface/dashboard 108, enabling the generation of compliance reports, key performance indicators (KPIs), and real-time alerts via an integrated push notification service.

FIG. 3 illustrates the internal architecture and component layout of the Gateway 210, which serves as the central field-level communication hub between the door access management module 106, the task verification system 104, the proximity detection device 204, and the Server 202. The Gateway 210 is built around a MicroComputer platform that integrates an ARM-based central processing unit (CPU) 304 operating under a real-time operating system (RTOS) 310. This allows the Gateway 210 to reliably handle multiple concurrent communication processes and ensure deterministic task execution, which is essential for time-sensitive access control and monitoring operations.

The Gateway 210 is capable of both wired and wireless communication. An Ethernet port 302 enables high-speed data transmission to the Server 202 when a wired network is available, while a USB-C 306 interface provides power input, which is regulated via an AC/DC converter 318. To safeguard the system, the USB-C interface 306 is electrically protected through an ESD/debounce/voltage protection module 320 that ensures resilience against transient voltages and static discharges.

The micro-computer interfaces with several peripheral modules through standard communication protocols. An I2C bus 312 connects to an NFC reader/writer 322, allowing the Gateway 210 to identify Badges (identification devices) 102 or other NFC-equipped elements during configuration or system interaction events. The HDMI interface 314 is used to drive an OLED display 324, which can provide real-time system status, prompts, or diagnostics to on-site personnel. General-purpose input/output (GPIO) pins 316 are connected to a piezoelectric speaker 326 for audio feedback or alerts and to a LoRaWAN concentrator module 328, which facilitates long-range, low-power wireless communication with the door access management module 106, the task verification system 104, and the proximity detection device 214.

Together, these hardware elements allow the Gateway 210 to function as a robust and adaptable communication bridge between the on-site devices and the centralized Server 202. It plays a vital role in aggregating data from the field, enabling bidirectional control, and ensuring that all identification device-based interactions, task verifications, and proximity events are communicated efficiently and securely to the Insight Analytics platform for further processing and visualization.

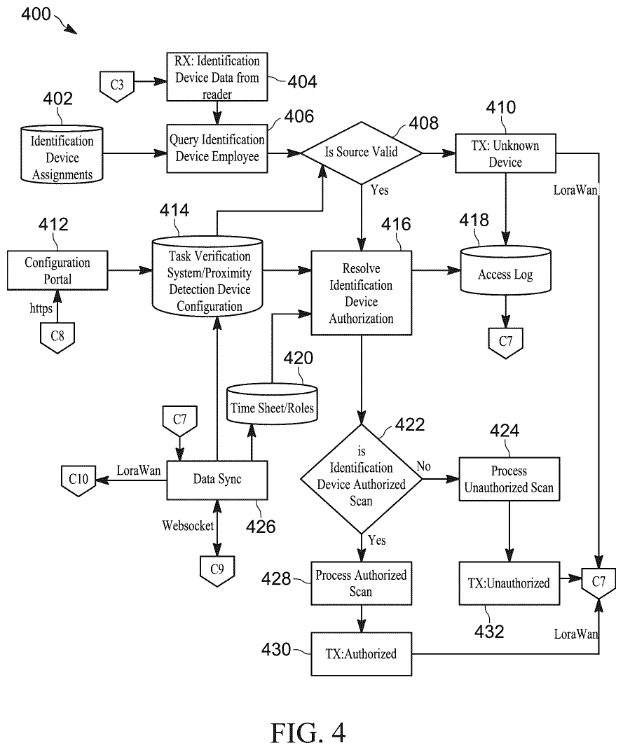

FIG. 4 is a flow chart 400 that shows the logical flow of operations performed within the Gateway 210 when interacting with an identification device 102 during a scan event. The Gateway 210 receives identification device data, step 404, via a LoRaWAN transmission from a local reader (RX: Identification device Data from Reader). Upon receiving the identification device signal, the Gateway initiates a query, step 406, to retrieve employee assignment data from a stored identification device Assignments database, step 402. It then validates the source of the data, step 408, to determine whether it originates from a recognized and properly configured reader or device. If the device is deemed invalid, step 410, the Gateway logs the scan, step 418, as originating from an unknown device and transmits this status via LoRaWAN to the appropriate door access management module 106, the task verification system 104, or the proximity detection device 204 as required.

If the device is valid, the Gateway proceeds to resolve the identification device's authorization status by cross-referencing a configuration database, step 416, comprising the current task verification system and proximity detection device assignments 414, and a Timesheet/Roles dataset 420, which contains the dynamic work schedule and role-based permissions for each employee. This combined context enables the Gateway 210 to determine whether the identification device holder is authorized for the specific operation, location, or task associated with the scan, step 422.

A valid scan leads to processing the event as an authorized action, step 428. This result is transmitted as an “Authorized” message, step 430, via LoRaWAN to the relevant modules, and the event is logged accordingly. Conversely, if the identification device 102 is not authorized based on the configured access criteria, the Gateway initiates an “Unauthorized” handling routine, step 424. This includes processing the unauthorized scan attempt, generating a log entry, and transmitting an “Unauthorized” status back to the scanning device or module (e.g., task verification system 104 or door access management module), step 432.

Supporting this workflow are several background services. A Data Sync module 426 ensures continuous alignment of role and timesheet data through WebSocket-based synchronization with the Server. This data is essential for real-time identification device validation. Additionally, the system configuration is managed via a secure HTTPS-based Configuration Portal 412, which pushes updates related to identification device assignments, access roles, and task verification system/proximity detection device parameters into the Gateway's configuration repository 414.

The illustrated flow thus defines a dynamic, secure, and context-sensitive access control and task authorization framework managed by the Gateway. It ensures that every identification device interaction is evaluated in real-time against multi-factor criteria including device validity, role assignments, task schedules, and configured permissions, and that all results—whether successful or denied—are appropriately logged and transmitted to downstream modules for operational awareness and audit tracking by the Insight Analytics platform.

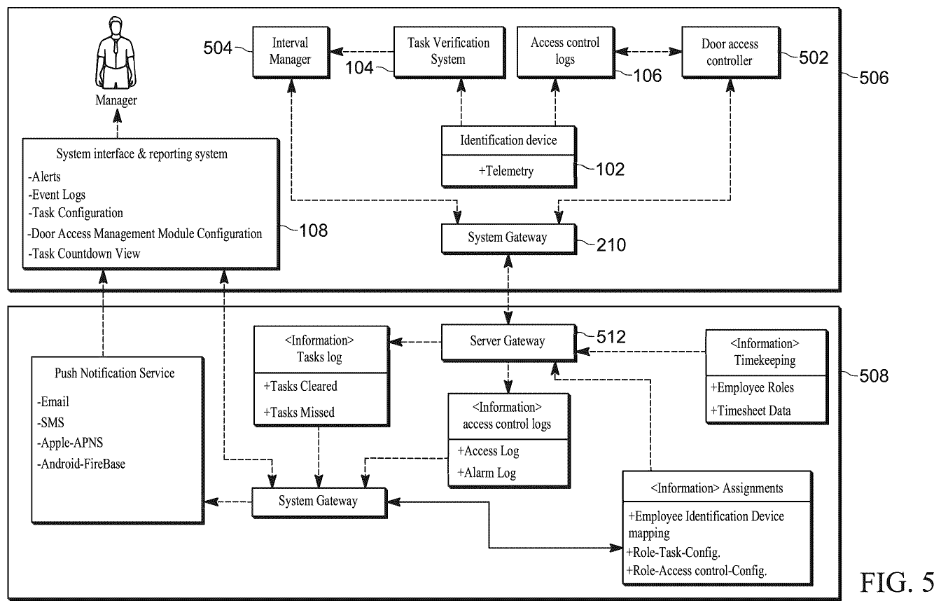

FIG. 5 illustrates an information flow diagram of a Door Access, Task Monitoring, and Control System. The system comprises multiple interconnected components that facilitate real-time monitoring, task tracking, and secure access control. The architecture is divided into two primary sections: a Field System 506 and a Backend System 508.

The Field System 506 includes an Interval Manager 504, the task verification system 104, the door access management module 106, the identification device 102, and a Door Access Controller 502. A Manager interacts with the system via a Dashboard or the system interface 108, which provides alerts, event logs, task verification system 104 configuration, door access management module settings, and a countdown view for tracking task completion. Employees carry identification devices 102 that collect telemetry data and interact with the task verification system 104 and door access management module 106 to log movement and task completion. The door access management module and Door Access Controller 502 regulate employee access based on predefined role configurations. All collected data is transmitted through a system Gateway 210, which serves as an intermediary between the Field System 506 and the Backend System 508.

The Backend System 508 processes and stores data received from the Field System 506. The Backend system 508 logs task verification system 104 and door access management module 106 data while maintaining employee assignments, which define identification device mappings, role-based task configurations, and role-based access control configurations. A Server Gateway 512 facilitates communication between backend system 508 components and external services. Logged data is categorized into task Logs, which track cleared and missed tasks, access Logs, which maintain access and alarm records, and Timekeeping Logs, which store employee roles and timesheet information. A Push Notification Service provides real-time alerts via email, SMS, Apple-APNS, and Android-Firebase when security events, missed waypoints, or access violations occur.

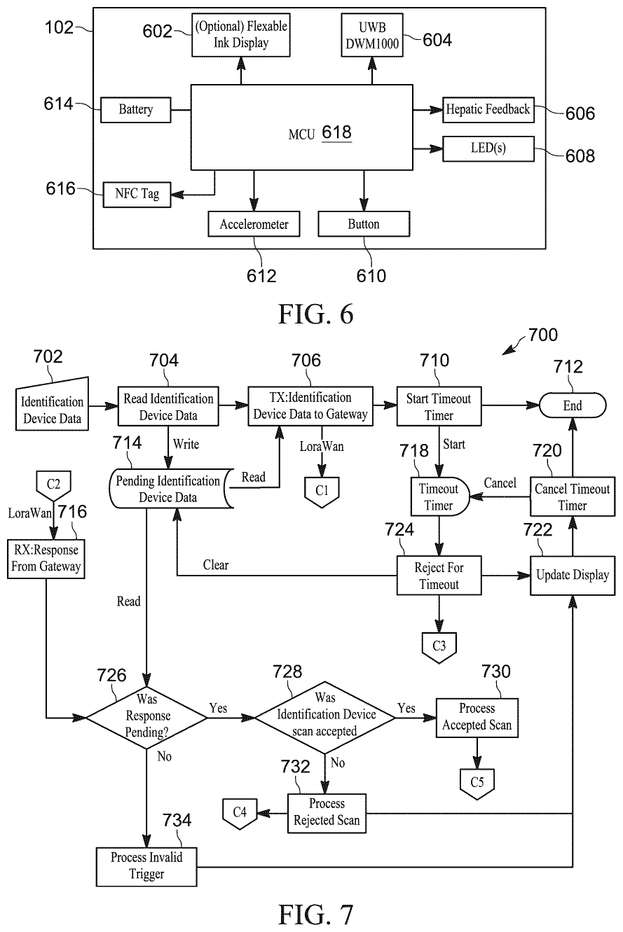

FIG. 6 illustrates the internal architecture of an identification device worn by personnel and is designed to interface seamlessly with the door access management module 106 and the task verification system 104. The identification device 102 or badge is configured in a form factor consistent with a typical employee ID card, intended to be worn via a lanyard or clipped onto clothing. It contains both hardware and embedded software components, enabling real-time interaction and authentication capabilities within the system.

At the core of the identification device 102 is a microcontroller unit (MCU) 618, which orchestrates all peripheral components and runs the firmware, including communication protocols and control logic. The identification device 102 is powered by a compact battery module 614, facilitating mobile and continuous operation. For identity and interaction functions, the identification device 102 includes an integrated NFC tag 616, allowing proximity-based communication with NFC readers embedded in the door access management module 106 and the task verification system 104. Additionally, a UWB (Ultra-Wideband) transceiver 604 (specifically, the DWM1000 module) is incorporated for high-accuracy spatial tracking and positioning, enabling proximity detection in conjunction with the proximity detection device.

The identification device 102 may optionally include a flexible ink display 602 to present dynamic, user-specific information such as role designation, time status, or authentication feedback. Input/output components connected to the MCU include one or more LEDs 608 for visual alerts, a haptic feedback module 606 for tactile confirmation of status (e.g., buzz on successful scan), and a push-button 610 for user interaction or acknowledgment. An embedded accelerometer 612 enables motion or orientation detection, which may be used for gesture-based activation or as part of presence verification within the system.

Each identification device 102 is assigned to a specific employee within the Dashboard or system interface 106, establishing an identity-to-device mapping. Real-time operational constraints, such as current clock-in status and active role (e.g., bartender, manager, cleaner), are continuously synchronized with the system. Upon an attempt to perform an action, such as unlocking a door via the door access management module 106 or initiating a task at a task verification system 104, the identification device 102 transmits identifying data and role context to the respective module. Authorization is granted only if the identification device 102 is marked active within the timekeeping system and, where applicable, the employee's role matches the access or task requirement.

Through the combination of real-time communication, embedded intelligence, and centralized role mapping, the identification device 102 provides a secure, efficient, and context-aware method of verifying employee actions throughout the managed environment.

FIG. 7 illustrates the operational process flow within the identification device Reader, which is embedded in the door access management module 106 or the task verification system 104. This figure details how the reader handles identification device interactions, communicates with the Gateway 210, and resolves identification device authorization status through a coordinated sequence of logic-driven steps.

The process begins when identification device data is detected, step 702, and read by the identification device Reader, step 704. This initiates a command to write the identification device data to a temporary storage buffer, termed Pending identification device Data, step 714. Once stored, the identification device data is transmitted (TX) to the Gateway via LoRaWAN communication, step 706. Simultaneously, a timeout timer is started, step 710, to ensure the system does not hang indefinitely in the absence of a response. If the Gateway fails to respond within a predefined time, the system triggers a timeout rejection process (C3), step 718, updates the display to reflect the timeout status, cancels the timer, and terminates the current transaction flow, step 724.

If a response is received from the Gateway (RX), step 716, the identification device Reader first checks whether a response is pending, step 726. If not, it flags the occurrence as an invalid trigger and exits via an error path, step 734. If the response was expected, the reader evaluates whether the identification device scan was accepted by the Gateway logic, step 728. If the identification device is authorized, the process routes through a path labeled C5, step 730, where the identification device scan is processed as accepted, the display is updated accordingly, step 722, and the timeout timer is canceled, step 720.

Conversely, if the identification device scan is not accepted by the Gateway—for reasons such as inactive status, invalid role, or unregistered user—the identification device Reader initiates the rejected scan path (C4), step 732, updates the display, step 722, with rejection feedback, and cancels the timeout timer, step 720. All scan outcomes (acceptance, rejection, or timeout) ultimately lead to the termination of the process cycle, step 712.

Throughout this process, the identification device Reader maintains efficient transaction control by reading and clearing the Pending identification device Data buffer as necessary. Additionally, user feedback is provided via the local interface—potentially using LEDs, haptic feedback, or visual display—ensuring intuitive interaction with the identification device.

This structured workflow supports secure, real-time validation of identification credentials for tasks or access control within the managed premises, leveraging the centralized decision-making capabilities of the Gateway and maintaining compliance with preassigned user roles and schedules.

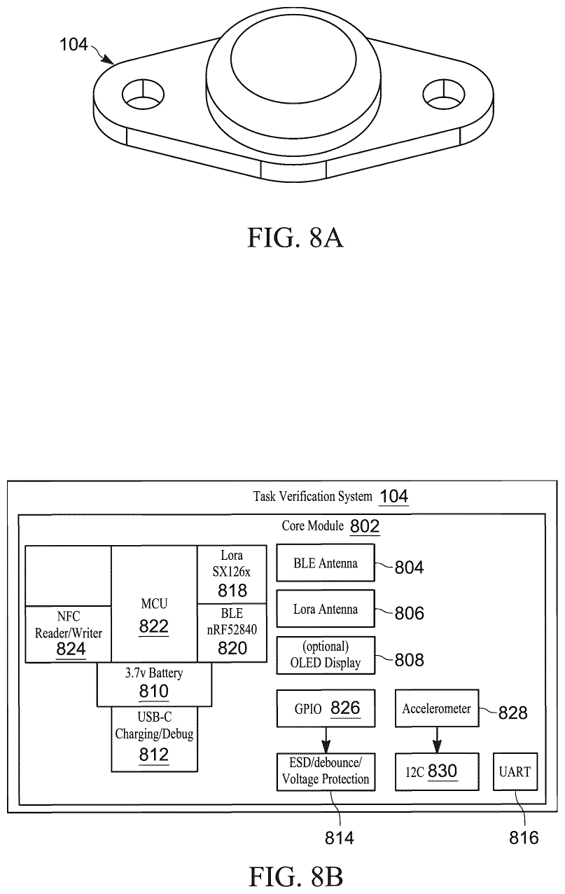

FIG. 8A illustrates a task verification system, and FIG. 8B illustrates an internal architecture of the task verification system, in accordance with an embodiment of the present invention. The Task Verification System 104, is a compact, battery-powered wireless device designed to be installed at fixed locations within a workplace. The core module 802 of the Task Verification System 104 comprises a Microcontroller Unit (MCU) 822, which is responsible for all internal operations and communication. The microcontroller unit 822 is interfaced with one or more wireless transceivers, such as a LoRaWAN module 818 for long-range, low-power communication with the Gateway, and a Bluetooth Low Energy module 820 that enables proximity-based communication and over-the-air updates or diagnostics.

The task verification system 104 includes an NFC reader/writer 824, allowing direct interaction with the identification devices, enabling authorization, task check-in/out, and context-based validation. This is the primary interface through which an employee scans the identification device 102 to trigger a verification event. A rechargeable battery 810 powers the module, with USB-C charging and debugging support for maintenance and deployment 812. The MCU 822 and peripheral components are safeguarded by ESD (electrostatic discharge) and debounce/voltage protection circuits 814, ensuring operational stability in industrial or high-traffic environments.

The task verification module may further comprise peripheral components, such as an OLED display 808, a BLE antenna 804, a LoRa antenna 806, a GPIO interface 826, an accelerometer 828, and a UART interface 816. The OLED display can be used for presenting local status messages, scan confirmations, or failure alerts. The BLE and LoRa antennas can be used to optimize wireless signal quality and range. The GPIO interface 826 can be used to support external triggers or indicators, such as LEDs, relays, or buzzers. The accelerometer 828 is connected via I2C 830, which enables motion or vibration-based feedback for wake-on-motion or impact-logging features. The UART interface 816 may be used for serial debugging or interfacing with additional external modules.

The Task Verification System 104 functions as a task verification and presence monitoring system, ensuring that employees complete required tasks or remain at designated locations as per operational requirements. It operates as a countdown timer, which must be periodically reset to confirm that a task has been completed (e.g., restroom cleaning, workstation sanitization) or that a specific position (e.g., hostess stand, security checkpoint) is occupied.

The countdown timer can be reset through two methods: physical contact reset via NFC, where an employee taps their identification device 102 on the Task verification system 104, or proximity-based reset via UWB, where the system detects the presence of an authorized identification device 102 within a predefined range. Each Task verification system 104 is preconfigured with a countdown interval over UWB and can be adjusted based on operational requirements. If an employee fails to reset the countdown timer within the set interval, the system generates an alert, which is escalated according to predefined rules, notifying supervisors or security personnel. To maintain control over authentication, each Task verification system 104 is assigned a list of authorized employee roles (e.g., cashier, security guard, hostess), ensuring that only employees currently on the clock and in an approved role can reset the timer. When an authorized identification device 102 interacts with the Task verification system 104, the system logs the event, capturing key details such as the timestamp, employee ID, and associated task or location.

All interactions between the Task verification system 104, the identification device 102, and the central monitoring system are securely encrypted, ensuring data integrity and preventing unauthorized access. Since Task Verification System 104 can be dynamically configured, businesses can customize countdown intervals, authentication methods, and alert escalation policies based on their operational needs. This adaptability allows the system to evolve alongside changing workplace requirements. In summary, the Task Verification System 104 serves as a real-time compliance enforcement tool, improving workplace accountability, task adherence, and security by ensuring employees perform required tasks on schedule and remain present at critical locations as needed.

The Task Verification System 104 is a monitoring device designed to ensure that employees complete scheduled tasks or remain stationed at designated locations. Depending on the specific operational requirements, a Task verification system 104 can function in either Contact Mode or Proximity Mode. In Contact Mode, Task Verification System 104 requires direct physical interaction from an authorized identification device 102 to reset its countdown timer. Employees must tap or swipe their identification device 102 against the Task verification system's built-in NFC or RFID reader to confirm their presence and task completion. This mode is particularly useful for scheduled inspections, security patrols, and maintenance checks, where employees must physically verify their visits. The Contact-based Task verification system 104 continuously runs a timer that must be reset within a predefined interval. It can be configured with various parameters, including a countdown timer to determine the reset interval, a debounce timer to prevent multiple quick resets, a reminder period to alert employees before the timer expires, and a grace period to allow late resets without triggering an alarm. Additionally, the system can define effective hours during which monitoring is active and configure alert severity levels, which may include event logging, audible alarms, or push/SMS notifications to managers.

In contrast, a Proximity-based Task verification system 104 automatically resets its timer when an identification device 102 is detected within a configured radius, eliminating the need for physical interaction. This mode is particularly useful for locations where personnel must always be present, such as a front desk, security station, hostess stand, or cashier counter. The Proximity Task verification system's timer starts when no identification device 102 is detected within the set radius. If an authorized identification device 102 does not return within the configured time, the system triggers an alert. Various parameters control the Task verification system 104 functionality, including detection radius, countdown timer, filter timer (which ensures the identification device 102 remains within the area for a minimum duration before resetting), reminder periods, and grace periods to differentiate between late and absent employees. Similar to the Contact-based Task verification system 104, the Proximity-based Task verification system 104 also supports effective hours configuration and different alert levels such as event logging, sound alarms, and manager notifications.

The primary distinction between the two modes lies in their method of confirming compliance—Contact-based requires physical interaction, ensuring employees actively acknowledge their presence at a location, whereas Proximity-based detects identification device presence automatically, making them ideal for roles requiring continuous stationing.

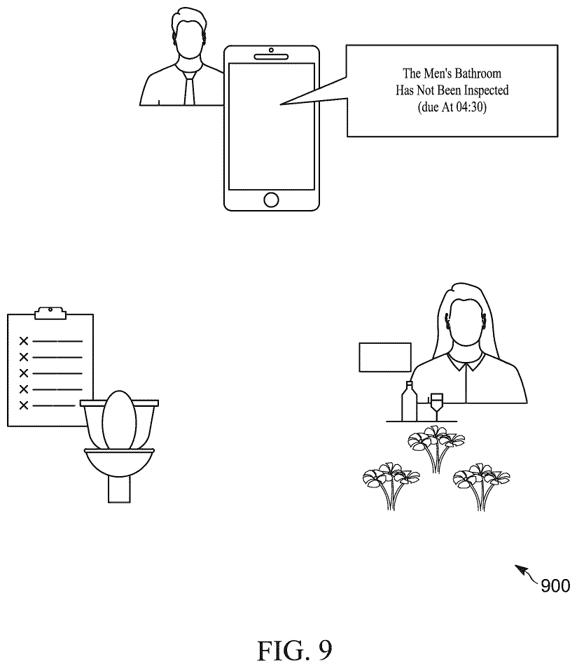

FIG. 9 illustrates an NFC-triggered task verification system for task monitoring and compliance tracking. The system ensures that designated locations 900 are inspected or attended to within a specified timeframe by authorized personnel. As depicted, the system includes NFC-enabled checkpoints positioned at key locations, such as a restroom (left side) and a plant inspection area (right side). Personnel are required to scan an NFC tag at these waypoints using a mobile device to confirm task completion and record their presence at the location.

In the event of a missed inspection, the system automatically generates an alert. As shown in the upper section of FIG. 9, a notification is sent to a manager, indicating that the men's restroom has not been inspected within the scheduled timeframe (due at 04:30). This ensures real-time compliance monitoring and prevents missed tasks. The system maintains an automated audit trail, improving accountability and operational efficiency.

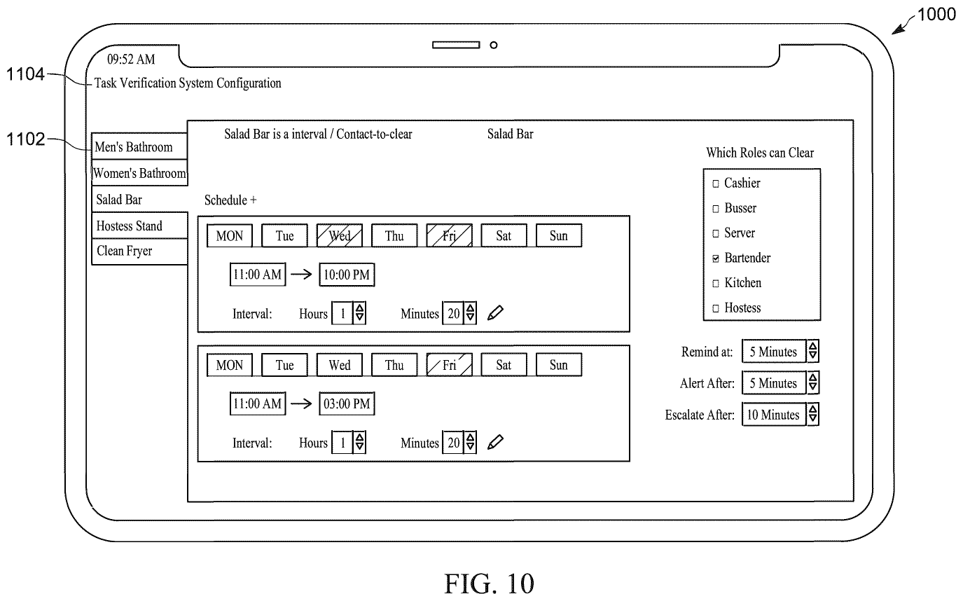

FIG. 10 illustrates an exemplary process for the task verification system configuration 1104, in accordance with an embodiment of the present invention. In the interface 1000, a user (typically an administrator or supervisor) can define, manage, and assign the operational schedule, validation conditions, and personnel roles associated with a specific task verification point. In this specific instance, the labeled “Salad Bar” is shown as an Interval/contact-to-clear type task.

The interface enables the selection of different location-based tasks or process-based tasks such as “Men's Bathroom 1102,” “Clean Fryer,” etc. Upon selecting a specific task (in this case, “Salad Bar”), the administrator can configure multiple time intervals during which the task must be verified via an identification device interaction. Each schedule block includes: Start and end times (e.g., 11:00 AM to 10:00 PM), Interval settings (e.g., every 1 hour and 45 minutes), and Days of the week the configuration applies.

This allows the system to prompt users at regular intervals to scan their identification device 102 at the designated task verification system 104, ensuring that routine checks, cleaning, or other maintenance activities are completed in a timely and verifiable manner.

Additionally, the interface provides a list of personnel roles eligible to clear the task, such as Cashier, Server, Bartender, etc. These roles correspond to the employee-role mappings managed through the central Gateway and Dashboard 108. A scan performed by an unauthorized role would be flagged or rejected.

In the configuration interface, the administrator can provide inputs, such as reminders (sets the time before the interval lapse to issue a gentle reminder), alerts (defines when a stronger alert is triggered if the task remains uncleared), and alert escalation (dictates when supervisory or managerial escalation occurs).

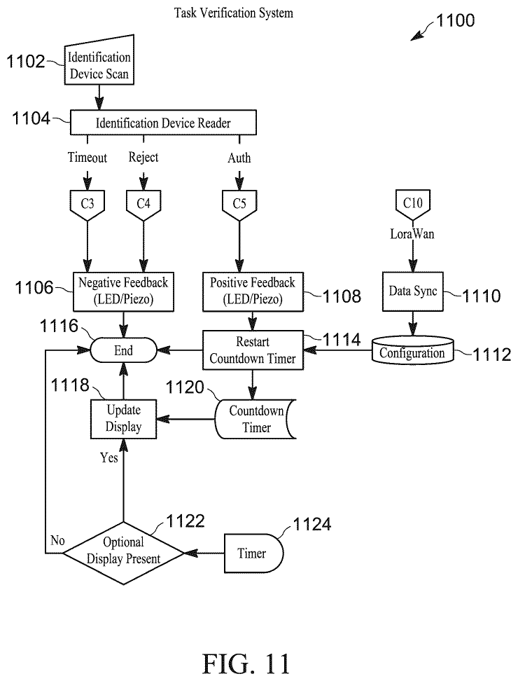

Referring now to FIG. 11, a flow diagram 1100 representing an exemplary method of operation for a task verification system is illustrated, in accordance with an embodiment of the present invention. The task verification system 104 is configured to interface with an employee identification device 102 for the purposes of real-time activity authorization and time-bound task validation.

The process begins at the identification device Scan block 1102, wherein a user presents their identification device to the task verification system 104. This triggers the identification device Reader module 1104, which reads the identification device credentials and initiates communication with the central authorization system via LoRaWAN or other wireless protocols.

Upon receipt of the identification device data, the system evaluates the validity within the context of its current configuration and timing rules. The response is processed according to one of the following paths: a Timeout Condition (C3): If no valid response is received within a predefined interval (e.g., due to connectivity issues or processing delays), the system invokes a timeout handler. This generates negative feedback, step 1106, through a visual or auditory indicator (e.g., LED flash or piezoelectric buzzer), and the process terminates without logging any task, step 1116; a Rejection Condition (C4): If the identification device 102 is recognized but fails the authorization check (e.g., the identification device holder is not currently active in the timekeeping system or lacks the required role for the task), the system triggers a rejection handler. Similar to a timeout, negative feedback is provided, step 1106, and the session ends without acknowledgment of task clearance, step 1116; an Authorization Success (C5): If the authentication device is authenticated successfully, the system proceeds with positive feedback to the user, step 1108. The process then activates a Restart Countdown Timer mechanism, step 1120, which resets the interval timing associated with the task (e.g., food station cleaning every 45 minutes). This restart signifies that the task was successfully cleared within the allowable timeframe.

Following successful identification device authentication, if the task verification system 104 includes an optional display interface 1122, the system updates the user-facing visual display 1118 to reflect the new timing status 1122 or relevant task data, ensuring transparency and on-site accountability.

Parallel to these interactions, the task verification system 104 may perform a LoRaWAN Data Synchronization function (C10), wherein the device communicates with the cloud-based Dashboard 108 to retrieve updated task schedules, authorized roles, and timing parameters, step 1110. This synchronization ensures that the local configuration of the task verification system 104 remains consistent with enterprise-level policies and operational mandates, step 1112.

In an embodiment, the proximity detection device 204 may be provided as a fixed-location wireless device designed to monitor and record personnel presence at designated locations within a workplace environment. Each proximity detection device 204 includes embedded software, a real-time clock, and a wireless communication module, which may include ultra-wideband (UWB), Bluetooth Low Energy (BLE), LoRaWAN, or any suitable wireless protocol. For purposes of illustration, UWB is the preferred implementation. The proximity detection device 204 is configured to function as an autonomous countdown timer that requires periodic reset events to indicate continued occupancy of the monitored location. If the countdown interval lapses without a valid reset, the proximity detection device 204 triggers an alert that may be reported to a centralized system or monitoring interface.

The reset condition is satisfied when an identification device 102, associated with a user authorized for that proximity detection device 204, is detected within a predefined proximity. Authorization is determined based on the employee's role (e.g., hostess, cashier, or server) and whether the employee is clocked in for an assigned shift. The detection of an authorized identification device 102 within the configured range causes the proximity detection device 204 to log the event and reset the countdown timer. To enhance configurability, each proximity detection device 204 may be programmed with a set of operational parameters, including but not limited to: (i) a detection radius defining the effective sensing zone, (ii) a countdown timer interval specifying the maximum duration between reset events, (iii) a presence timer establishing the minimum amount of time an identification device 102 must remain within range to qualify as a valid reset, (iv) a reminder period used to prompt pre-expiration notifications, (v) a grace period during which late resets are accepted without escalation, (vi) effective hours to enable or disable monitoring automatically based on time-of-day or day-of-week, and (vii) alert severity configurations that determine the type and escalation path of alerts, such as dashboard flags or push/SMS notifications to supervisors.

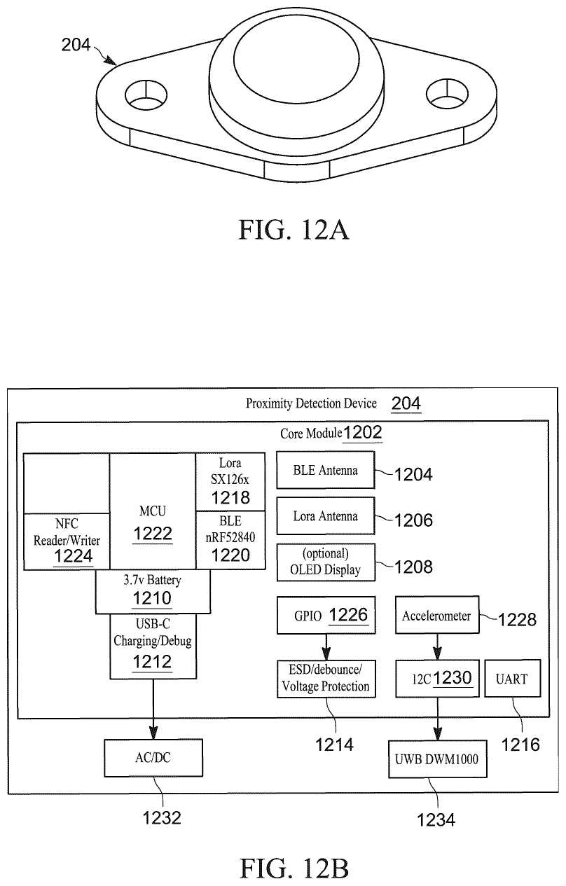

FIG. 12A illustrates a proximity detection device, and FIG. 12B illustrates an internal architecture of the proximity detection device, in accordance with an embodiment of the present invention. The core module 1202 of the proximity detection device 204 is a microcontroller unit (MCU) 1222, which orchestrates communication and processing functions. The MCU 1222 is coupled to a LoRa (long-range wireless) module 1206 and a BLE (Bluetooth low energy) module 1204 to enable long-range and short-range wireless communication, respectively. The proximity detection device 204 includes a UWB module 1234, which is interfaced via I2C 1230 or UART 1216 and facilitates high-precision proximity detection based on ultra-wideband ranging technology.

The system is powered by a rechargeable battery 1210, with USB-C support for charging and debugging 1212. An NFC Reader/Writer module 1224 is also included, enabling near-field communication for detection of identification device or device configuration. Peripheral interfaces include general-purpose input/output (GPIO) lines 1226, optional OLED display support 1208 for local visual feedback, and an accelerometer 1228 for detecting motion or tampering. Hardware protection features such as ESD protection, debounce logic, and voltage protection 1214 are integrated to ensure stability and resilience in various deployment environments. Antennas for both BLE 1204 and LoRa 1206 are shown separately, ensuring proper signal isolation and communication efficiency.

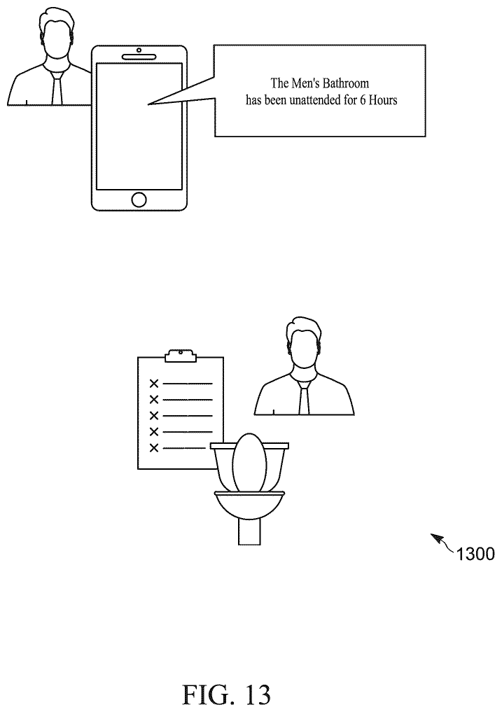

FIG. 13 illustrates a system for monitoring staff presence at designated locations 1300 using the proximity detection device. The system is designed to track attendance and ensure that critical service areas remain staffed.

Personnel are required to check in at regular intervals to confirm their presence. If no check-in is detected within a predefined period, the system generates an alert. For example, a reception area is equipped with a proximity detection device, such as a NFC tag or a presence sensor. The proximity detection device sends an alert to the manager if no check-in is detected within a predefined period.

In the depicted scenario, the system is inspecting a bathroom site for presence of a housekeeping staff in a bathroom. The proximity detection device detects the presence of the housekeeping staff if an identification device is detected. In case of no check-in, an alert is sent to the manager. The upper portion of FIG. 13 shows a notification being sent to a manager, indicating that the bathroom has not been attended for 6 hours.. This enables real-time monitoring and ensures that service areas remain staffed without disruption

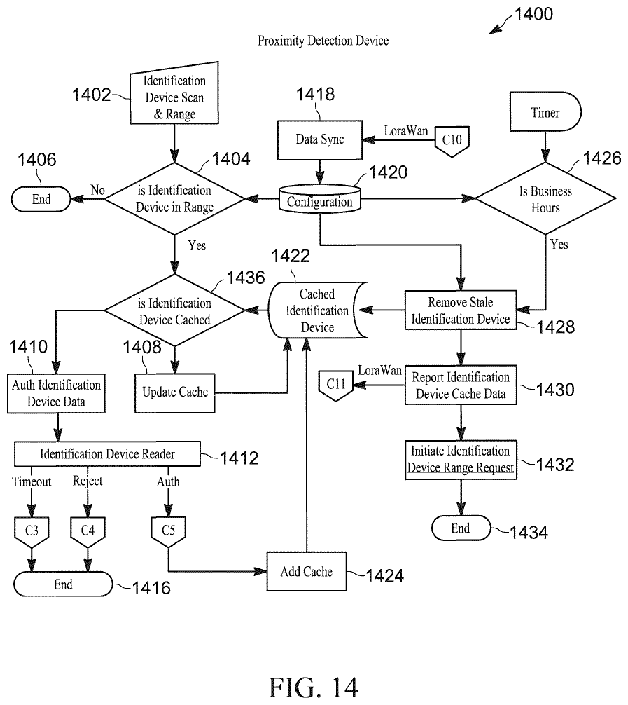

FIG. 14 illustrates an operational flow 1400 for the proximity detection device 204, detailing the detection, authorization, caching, and timer-reset logic as performed by the proximity detection device during regular operation.

The process begins with an identification device Scan & Range operation, step 1402, which utilizes ultra-wideband (UWB) to detect whether an identification device 102 is within the configured proximity of the proximity detection device, step 1404. If no identification device 102 is detected within range, the process ends, step 1406. If an identification device 102 is detected, the system evaluates whether the identification device 102 is already present in the Cached list of the proximity detection device, step 1436. If the identification device 102 is not cached, the proximity detection device queries the identification device authorization data, step 1410, via a Reader module 1412. If the identification device 102 is authenticated successfully, the cache is updated, step 1408, and the identification device 102 is added to the local cache list, step 1422.

Identification device authentication can result in three outcomes: A Timeout (C3) occurs if no response is received within the allowed period; A Reject (C4) outcome is returned if the identification device 102 is not associated with an authorized role or active shift and process is terminated, step 1416; An Auth (C5) response is returned if the identification device 102 is valid, authorized, and associated with an active employee role, and cache is added, step 1424 to cache identification device 1422.

If the identification device 102 is already cached, the system skips reauthorization and proceeds to validate it using the locally stored data. This reduces unnecessary network calls and improves responsiveness.

In parallel, the proximity detection device operates a Timer module to determine whether the system is within Business Hours as defined in the configuration, step 1426. If yes, the proximity detection device performs periodic housekeeping to Remove the Stale identification device from the cache, step 1428. This involves comparing the last detection time against a timeout threshold and removing entries that are no longer relevant.

To maintain synchronization with the central server, the proximity detection device may initiate a Report Cache Data operation, step 1430, transmitting cached identification device interactions over a LoRaWAN connection (represented by label C11) for system logging, alerting, or analytics purposes. This may be followed by an identification device Range Request initiation to refresh identification device proximity data when necessary, step 1432, and the process is terminated, step 1434.

Configuration data 1420 for the proximity detection device 204, including timer settings, business hour definitions, and authorization lists, is synchronized periodically through a Data Sync process 1418 over the LoRaWAN interface (noted as C10). This ensures each proximity detection device operates with up-to-date parameters reflective of system-wide policy or operational updates.

In an embodiment, the door access management module 106 is designed to monitor and regulate entry into protected areas using employee identification device 102 as authentication credentials. The door access management module 106 consists of embedded software, a door sensor, a real-time clock, a card reader, and a wireless communication module. The card reader supports NFC or RFID-based authentication, allowing employees to tap their identification device 102 to gain access. For secure data transmission and communication with the broader system, the door access management module 106 utilizes UWB, BLE, or LoRaWAN wireless protocols, with NFC and UWB planned as primary implementations.

One of the key features of the door access management module 106 is its ability to integrate with third-party electronic door locks via normally closed (NC) or normally open (NO) relays. While it supports direct lock control, in many cases, the monitored doors may remain unlocked to comply with fire safety regulations. Even in such scenarios, the door access management module 106 serves as a tracking and alerting mechanism, ensuring that every entry attempt—both authorized and unauthorized—is logged for security auditing and workflow analysis.

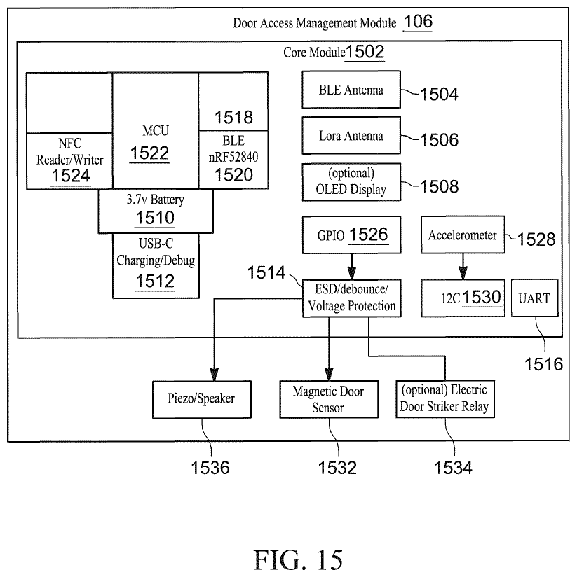

FIG. 15 illustrates a hardware implementation of the door access management module 106 responsible for personnel tracking and access management. The door access management module 106 is structurally similar to the proximity detection device but includes additional components specifically intended for door monitoring and access control functionalities.

At the core of the door access management module 106 is the Core Module 1504, which comprises a Microcontroller Unit (MCU) 1522 that manages internal processing and communication. The MCU 1522 interfaces with both a LoRa module 1518 for long-range wireless communication and a BLE module 1520 for short-range connectivity and peripheral integration. These modules enable the device to transmit and receive data from other devices and cloud-based infrastructure using either BLE or LoRaWAN protocols.

The system includes an NFC Reader/Writer 1524, enabling secure, near-field identification device interaction. Power is supplied by a rechargeable battery 1510, and the device supports USB-C charging/debugging capabilities 1512.

Various peripherals and expansion components are supported via GPIO lines 1526 and protected by ESD/debounce/voltage protection circuitry 1514 to ensure robust operation in diverse environments. The device may optionally incorporate an OLED display 1508 for visual output and user feedback, and an accelerometer 1528. Antennas for BLE 1504 and LoRa modules 1506 are included for optimized wireless performance.

For access control and entry monitoring purposes, the door access management module 106 further includes a Magnetic Door Sensor 1532, which detects door open/closed states. This sensor enables real-time event logging of door activity for audit and compliance monitoring. Additionally, an optional Electric Door Strike Relay 1534 may be integrated, allowing the system to control physical locking mechanisms, thereby enabling or denying access based on real-time identification device authorization.

A Piezoelectric speaker 1536 is also included for acoustic signaling, such as entry/exit notifications, alerts, or user feedback tones. The system can detect physical tampering or environmental changes through an onboard accelerometer, interfaced via I2C 1530.

All components are coordinated through the core firmware running on the MCU, enabling the door access management module 106 to autonomously determine whether access should be granted or denied based on identification device proximity, role authorization, and system policy, while also communicating status and events to the gateway of the system.

In this configuration, the door access management module 106 acts not only as a passive monitoring device but also as an active control point in physical security workflows, particularly useful in environments such as secure facilities, restricted office areas, or service counters where access must be regulated based on user credentials and time-sensitive roles.

In an embodiment of the present invention, the proximity detection device and the door access management module 106 can be configured in a way similar to the configuration of the task verification system as illustrated in FIG. 10.

The door access management module 106 functions similarly to the task verification system 104, in that it is assigned employee roles that define access permissions. Employees must be actively on the clock and assigned an authorized role to gain entry. When an employee scans their identification device 102, the door access management module 106 system validates their credentials against stored access permissions. If the scan is authorized, the system logs the access event—including timestamp and employee ID—and creates an “access window” during which the door may be freely opened. If the employee fails to scan their identification device 102 before opening the door, or if an unauthorized person attempts access, an alert is triggered.

The alert system includes multiple layers of security and notification mechanisms. Unauthorized access attempts are logged, allowing managers to track attempted breaches. If the door is opened outside of an access window, the door access management module 106 generates an audible alarm to notify nearby personnel and encourage compliance. Additionally, these alerts are sent to the Dashboard or system interface 108, where security personnel or managers can review them. The exact timestamp of the unauthorized event can be used to correlate with security camera footage, providing a precise record for incident investigation.

To clear an alert, an employee must successfully scan their identification device 102, confirming that they acknowledge the security protocol. This ensures that even if an employee accidentally forgets to scan their identification device before entry, they have a chance to rectify the action without escalating the incident further.

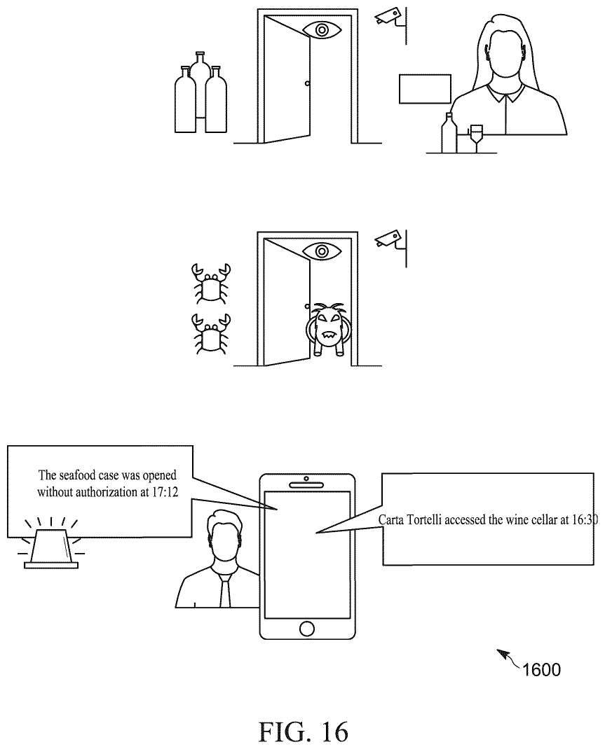

FIG. 16 illustrates a system for monitoring doorway access and unauthorized entry using NFC-enabled checkpoints, surveillance cameras, and automated alerts. The system ensures secure access control to restricted areas 1600 and detects unauthorized activities in real time.

In the upper section, an authorized employee is depicted scanning an NFC-enabled identification device 102 at a secured doorway, likely to access a controlled area such as a wine cellar. The system logs and records the event, as seen in the lower right notification, which confirms that “Carla Tortelli accessed the Wine Cellar at 16:30”. The system′ can track and verify authorized personnel movement.

In the middle section, a security threat is represented, showing an unauthorized entry scenario. The security camera suggests a breach or attempted unauthorized access to a restricted seafood storage area.

The lower left notification highlights a security alert, indicating that “The Seafood case was opened without authorization at 17:12”, triggering a real-time alert to the manager. This suggests that the system detects unauthorized actions, such as accessing restricted areas without proper authentication.

The monitoring system integrates NFC-based authentication, real-time logging, and security alerts, ensuring compliance with access protocols and enhancing security in sensitive environments such as hospitality, retail, and food storage facilities.

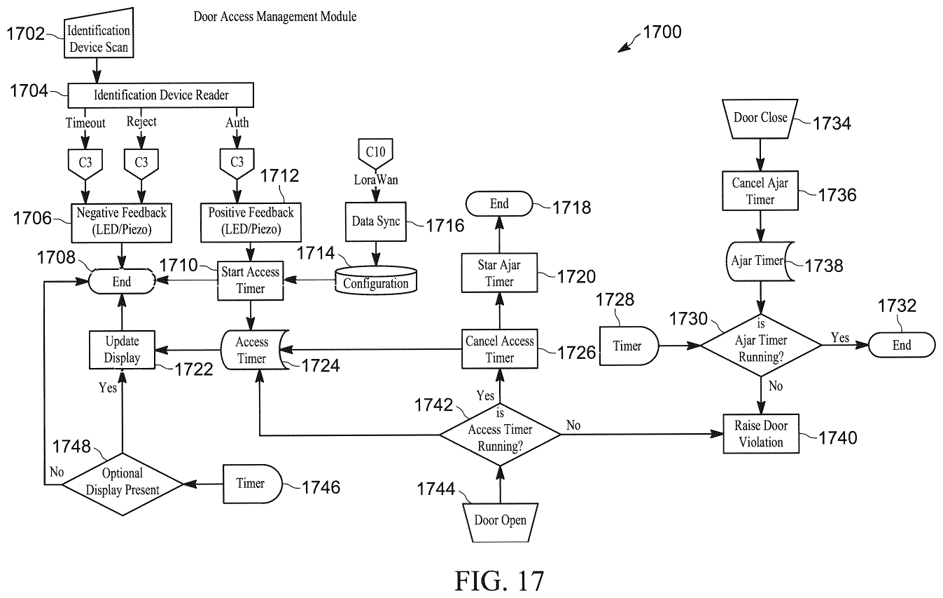

FIG. 17 is a functional flow diagram 1700 of the door access management module 106, illustrating the process flow from identification device detection to door access management and door state monitoring, in accordance with an embodiment of the present invention.

The process begins with an identification device Scan event 1702, which is processed through the Reader 1704. The reader evaluates the identification device scan result and classifies it into one of three outcomes: Timeout (C3): No identification device is detected within the expected time window, triggering negative feedback through a visual (LED) or audio (piezo) indicator 1706 and ending the process 1708; Reject (C4): The identification device is detected but fails authentication (e.g., role mismatch, inactive user), which also triggers negative feedback 1706 and terminates the interaction 1708; Auth (C5): A valid identification device is authenticated. In response, positive feedback (via LED or piezo) is provided 1712, and the system initiates the Access Timer 1710 and access timer is started 1724.

The Access Timer 1746 controls the window during which the door is expected to be opened after a successful identification device read. If an optional display is present 1748, the system updates it 1722 with user or status information during this timer period.

Once the door is detected as opened 1744, the system checks if the Access Timer is still active 1742. If so, the Access Timer is canceled 1726, and the door is allowed to remain open without triggering any violations 1720, and the process end 1718. If the door is opened without an active access timer, it is interpreted as unauthorized, and the system raises a Door Violation alert 1740.

Simultaneously, when the door is opened, the system initiates an Ajar Timer 1728—a secondary timer that monitors how long the door remains open. This timer ensures that the door is not held open beyond a permissible threshold. If the door is closed 1734 before the Ajar Timer expires 1736, the timer is canceled, and the process ends normally 1732. If the ajar timer is active 1738, and system determines for the ajar time running or not 1730. If not, the system identifies a door-ajar violation and may escalate the alert 1740.

The system periodically synchronizes 1716 its configuration and operational data with a central server or cloud platform using LoRaWAN 1714, as indicated by the C10 data sync node. These syncs ensure that identification device credentials, timer intervals, and device settings remain up to date across the distributed system.

The functional logic allows the door access management module to act both as an access validator and a policy enforcer for physical access points, combining proximity-based authentication with environmental awareness (door state) and intelligent timing controls to maintain security compliance and reduce unauthorized access events.

In an embodiment of the present invention, the Dashboard is the system interface 108 for monitoring workplace tasks, security events, and employee access in real time. The system interface 108 is designed to provide employees, managers, and other stakeholders with clear visibility into active Waypoints, pending task timers, and access control activities. Available as both a tablet-based system placed in key areas such as break rooms or manager offices and a mobile application for remote access, the Dashboard or the system interface 108 enables communal accountability by encouraging employees to complete tasks on time while allowing managers to track compliance.

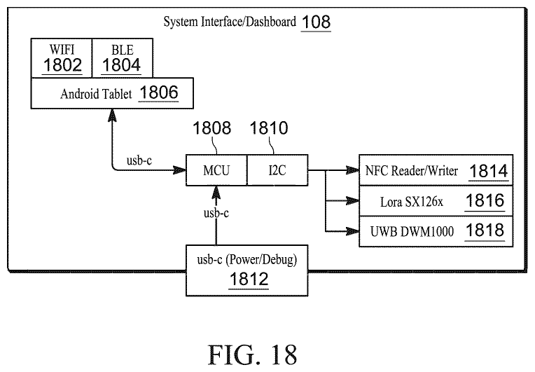

FIG. 18 illustrates the architecture of the Dashboard or system interface 108, which serves as a supervisory control and visualization interface within the broader system. The dashboard 108 is designed to facilitate configuration, real-time monitoring, and control of the various distributed components, including the proximity detection device 204, door access management module 106, and identification devices 102. The Dashboard 108 is built around an Android tablet 1806 that serves as the primary user interface. The tablet is equipped with WiFi 1802 and Bluetooth Low Energy (BLE) 1804 connectivity, enabling it to wirelessly communicate with peripheral devices and cloud-based management systems.

The Android tablet 1806 connects to a microcontroller unit (MCU) 1808 via a USB-C interface. The MCU 1808 acts as a bridge between the tablet and several specialized hardware modules. These modules include an NFC Reader/Writer 1814 for identification device provisioning and reading, a LoRa SX126x module 1816 for long-range wireless communication with remote devices, and a UWB (Ultra-Wideband) DWM1000 module 1818 for precise proximity detection and localization of identification devices. Communication between the MCU 1808 and these modules is handled through an I2C interface 1810. The MCU 1808 also features an additional USB-C interface 1812 for power input and debug operations.

This Dashboard 108 configuration enables operators or administrators to locally manage identification device authentication rules, proximity parameters, and alert settings. It supports real-time synchronization of configuration data to the proximity detection devices and door access management modules via LoRaWAN or BLE. The integrated hardware modules allow the Dashboard 108 to perform diagnostics, capture telemetry data, initiate OTA updates, and verify identification device interactions using UWB. In some embodiments, the tablet may also display access logs, real-time alerts, and system analytics, providing a comprehensive view of personnel access and presence across a monitored environment. The Dashboard 108 is thus a key component in the overall system, combining interactive control with robust communication capabilities to manage physical access, compliance, and operational readiness.

A key function of the Dashboard or the system interface 108 is displaying the status of active task verification system 104 in a structured grid format. Each task verification system 104 shows a countdown timer both in text and visually through a color-coded perimeter display. This color-coding system provides a quick reference to the urgency of the task, shifting from neutral color for elapsed time to green, yellow, and red as the deadline approaches or expires. Surrounding the countdown display is an additional segmented ring, where each segment represents past task completions. These segments use green for on-time completions, yellow for late completions within the grace period, and red for missed tasks, allowing managers to track employee adherence over time.

Beyond task tracking, the Dashboard or the system interface 108 also plays a critical role in security and access control by displaying real-time alerts generated by the system. If an employee attempts unauthorized access through the door access management module 106, the event is immediately logged and displayed, along with timestamps and employee details. Managers can acknowledge and dismiss these alerts directly from the Dashboard 108. Additionally, all identification device scan attempts—both successful and unsuccessful—are logged, making it easy to investigate access issues and potential security breaches.

For compliance and security audits, the Dashboard or system interface 108 can generate detailed reports summarizing all access attempts, including unauthorized entry attempts and failed identification device scans. These reports can be cross-referenced with security camera footage to assist in investigating theft, unauthorized access, or other security concerns. By integrating real-time task tracking, security monitoring, and historical reporting, the Dashboard or the system interface 108 provides an efficient way to enhance operational accountability and workplace security.

The system plays a crucial role in ensuring that employees complete periodic tasks and remain present at required locations. While individual lapses trigger real-time alerts, the system also gathers long-term performance data, enabling businesses to analyze trends and generate Key Performance Indicators (KPIs) for workforce productivity and accountability.

Each task is assigned to a set of authorized employee roles. These tasks can be individual responsibilities (such as a single employee performing a station check), team-based duties (where multiple employees share accountability), or managerial oversight responsibilities. Every time a task is either completed or missed, the system logs not only the individual employee responsible but also the team assigned to the task and the supervising managers. The system determines the responsible team dynamically by identifying all employees clocked in under the relevant role at the time of the task event. This structured logging ensures that performance metrics are tracked at multiple levels—individual, team, and managerial.

By aggregating this data over time, businesses can assess patterns of productivity, consistency, and accountability. The KPI system helps identify top performers—employees who regularly take the initiative to complete tasks—as well as those who may be neglecting certain responsibilities. Additionally, the system evaluates managerial effectiveness by analyzing whether supervisors are ensuring compliance within their teams.

Managers can view KPI data directly from the Dashboard or the system interface 108, providing real-time insights into workforce performance. The data is also exportable via REST APIs and available for direct download, allowing businesses to integrate these performance metrics into external reports and performance evaluation systems. This comprehensive approach enhances transparency, accountability, and operational efficiency, ensuring that all employees, teams, and managers contribute effectively to workplace operations.

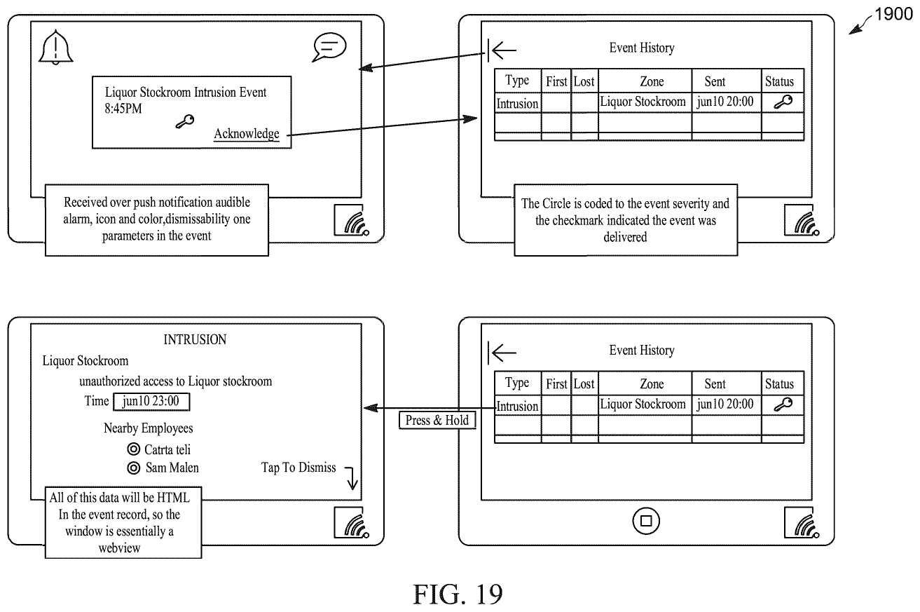

FIG. 19 illustrates a system interface/Dashboard for generating and managing security alerts related to an intrusion event in a monitored area. The system is designed to detect unauthorized access and notify relevant personnel through an interactive user interface. The figure comprises multiple screens 1900 that display the alert generation, event history logging, and user acknowledgment process.

Upon detection of an intrusion event, such as unauthorized access to a Liquor Stockroom, the system triggers a push notification to the user interface. This notification includes an audible alarm, an icon indicator, and an acknowledgment option, all of which are configurable parameters. The alert provides details such as the event type (Intrusion), the specific location (Liquor Stockroom), and the timestamp of occurrence (8:45 PM).

The system maintains an Event History Log, which records details of all intrusion events. The log displays columns for event type, employee details (if available), affected zone, timestamp, and event status. The severity of the event is visually represented by a color-coded circle, while a checkmark indicates the successful delivery of the event notification. Users can navigate through the event history to review previous alerts and security incidents.

Additionally, the system provides a detailed event view that allows authorized personnel to inspect the list of nearby employees present at the time of the intrusion. This information is dynamically retrieved in HTML format, ensuring real-time updates and web-based accessibility. The interface includes an option to dismiss the alert by tapping, allowing for streamlined acknowledgment of events once they have been reviewed.

The system also features an interactive “Press & Hold” function for confirming actions, ensuring that critical alerts are not dismissed accidentally. This security measure adds an additional layer of confirmation before acknowledging or clearing an event from the log.

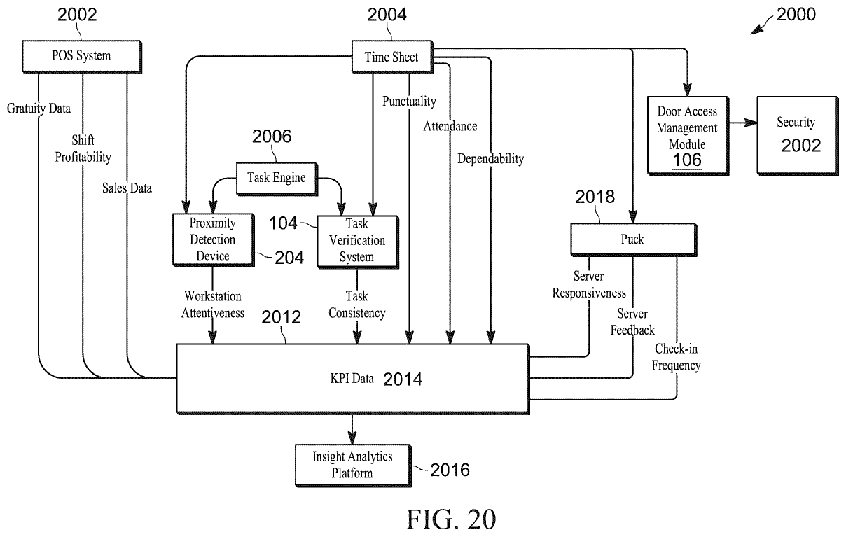

FIG. 20 illustrates a system-level architecture for real-time personnel performance monitoring and key performance indicator (KPI) tracking, in accordance with an embodiment of the present invention. The system is particularly well-suited for environments such as hospitality, healthcare, or manufacturing, where personnel behavior, task adherence, and situational awareness are critical to operational efficiency and accountability.

In the architecture 2000, data is aggregated from multiple sources, including the Point of Sale (POS) system 2002, Timesheet system 2004, and embedded IoT modules such as the proximity detection device 204, task verification system 104, door access management module 106, and a Puck 2018. The POS System 2002 provides operational metrics like sales data, shift profitability, and gratuity data, which are directly associated with individual or team performance. The Timesheet system 2004 contributes foundational human resources data such as punctuality, attendance, and dependability, which form a part of the behavioral KPIs.

The Task Engine 2006 interfaces with the proximity detection device 204 and the task verification system 104 to monitor and evaluate workstation attentiveness and task consistency, respectively. The proximity detection device 204 may be a proximity-sensing device that logs presence and interactions, while the task verification system 104 is responsible for validating task execution through NFC, QR code, or UWB mechanisms. These modules feed data into the centralized KPI Data Engine 2014, which forms the computational core for performance analytics.

The Puck 2018 is a mobile or wearable module used by staff (e.g., service personnel), and it captures real-time server responsiveness, check-in frequency, and server feedback. The puck can be the identification device. These interactions also contribute directly to the KPI dataset. The door access management module 106, which controls access points, contributes event data (such as unauthorized access attempts or inactivity) related to security 2002. Any security related event may trigger a Security Alarm, and also informs the overall dependability and punctuality metrics.

All of these diverse data points converge into the KPI Data Engine 2014, where they are aggregated, normalized, and scored according to pre-defined evaluation logic. The output is then visualized and reported through the Insight Analytics platform 2016, which allows managerial staff to analyze individual, team, or departmental performance trends in real-time. This system not only ensures accountability and workforce transparency but also supports incentive models, workload balancing, and incident response through data-driven insights.

This integration of physical access control, task tracking, and performance analytics within a modular, IoT-enabled system forms a unique and inventive framework for next-generation workforce management and is proposed herein as part of the patent specification.

The invention is applicable in various industries, including corporate offices for employee attendance tracking and secured area access, manufacturing facilities to ensure compliance with safety procedures and restricted equipment access, healthcare institutions to control access to sensitive areas like operating rooms and medication storage, and high-security zones to enhance surveillance and prevent unauthorized entry into critical locations.

The present invention provides a comprehensive workplace monitoring and access control solution that enhances security, ensures task adherence, and prevents unauthorized access. By integrating automated task verification, dynamic access control, real-time reporting, and adaptive security measures, the system optimizes workforce management and enhances workplace security across multiple industries.

Various modifications to these embodiments are apparent to those skilled in the art, from the description and the accompanying drawings. The principles associated with the various embodiments described herein may be applied to other embodiments. Therefore, the description is not intended to be limited to the embodiments shown along with the accompanying drawings but is to provide the broadest scope consistent with the principles and the novel and inventive features disclosed or suggested herein. Accordingly, the invention is anticipated to hold on to all other such alternatives, modifications, and variations that fall within the scope of the present invention and appended claims.

What is claimed is:

1. A system for workplace monitoring and access control to ensure policy compliance, comprising:
an identification device, associated with a user, configured to enable authentication and communication with the system;
a task monitoring module, configured to:
detect presence of the identification device within a designated area;
log task-related events;
verify task completion based on predefined conditions;
an access control module, configured to:
authenticate the identification device for access authorization;
regulate entry to a secured area via an access control mechanism;
generate alerts in response to unauthorized access attempts. a policy module containing compliance rules stored in a database; and
an employee supervisor module comparing results from the task monitoring module and the policy module to ensure compliance and measure employee performance.

2. The system of claim 1, the system further comprising:
an interface configured to display status updates regarding task completion and access control and generate reports related to user activity and compliance; and
an artificial intelligence engine using the results of the employee supervisor module to generate a schedule.

3. The system of claim 1, wherein the system dynamically adjusts monitoring and access control based on user status and predefined operational criteria; and
wherein the user is an employee, and wherein the schedule optimizes employee assignment and profitability based on employee past performance and employee availability while complying with the compliance rules.

4. The system of claim 1, wherein the task monitoring module comprises:
a countdown time requiring periodic resets to confirm task completion;
a reader to detect an unauthorized identification device; and
a proximity detection system to verify a user's presence within a specified range.

5. The system of claim 1, wherein the access control module comprises:
a door access control mechanism integrated with third-party electronic locks;
and an alert system for unauthorized access attempts.

6. The system of claim 1, wherein the task monitoring module operates in a contact mode, requires physical interaction with the identification device for validation.

7. The system of claim 1, wherein the task monitoring module operates in a proximity mode, detecting the identification device within a defined range.

8. The system of claim 1, wherein the access control module provides a time-limited access window upon successful authentication.

9. The system of claim 1, wherein alerts from the task monitoring module and access control module are escalated via push notifications, SMS, or email based on severity levels.

10. The system of claim 2, wherein the interface generates key performance indicators (KPIs) and historical analytics for user task adherence and access behavior.

11. A method for workplace monitoring and access control to ensure policy compliance, comprising:
assigning a user an identification device uniquely associated with the user's identity;
deploying a task monitoring module at task locations to:
detect the identification device using wireless communication;
log task completion events and timestamps;
trigger alerts for missed tasks based on a predefined schedule;
utilizing an access control module to:
verify identification device credentials before granting access;
log authorized and unauthorized access attempts; and
trigger security alerts upon detecting unauthorized entry attempts;
reading into a policy module a set of compliance rules stored in a database; and
comparing results from the task monitoring module and the policy module, wherein the comparison is performed in a supervisor module to ensure compliance and measure employee performance.

12. The method of claim 11, further comprising:
providing an interface to: display task adherence and access control status in real-time, and generate reports on user compliance and security events; and
using an artificial intelligence engine on the results of the employee supervisor module to generate a schedule, wherein the user is an employee and wherein the schedule optimizes employee assignment and profitability based on employee past performance and employee availability while complying with the compliance rules.

13. The method of claim 11, wherein the identification device comprises a wireless communication module configured to facilitate authentication via at least one of near-field communication (NFC), ultra-wideband (UWB), Bluetooth, or RFID.

14. The method of claim 11, wherein the task monitoring module dynamically adjusts task validation intervals based on user role, location, or historical compliance data.

15. The method of claim 11, wherein the access control module temporarily overrides access restrictions in response to emergency conditions or supervisor authorization.

16. The method of claim 11, wherein task completion and access control data are secured using encryption and multi-factor authentication to ensure data integrity and prevent unauthorized modifications.

17. The method of claim 12, wherein the interface integrates with third-party workforce management software to synchronize work schedules, task assignments, and user access permissions.

18. The method of claim 11, wherein alerts generated by the task monitoring module and access control module are categorized by severity and delivered via multiple communication channels, including push notifications, SMS, email, or automated voice messages.

19. The method of claim 12, wherein the interface provides predictive analytics to identify patterns in task adherence and access behavior, enables proactive workforce optimization.

20. The method of claim 11, wherein access attempts and task completion events are logged with geolocation metadata for enhanced auditability and compliance tracking.
